(19) United States
(12) Patent Application Publication
(10) Pub. No.: US 2010/0084913 A1
(43) Pub. Date: Apr. 8, 2010

(54) ELECTRONIC CONTROL BRAKE SYSTEM

(75) Inventors: Yong Suk HWANG, Seoul (KR); I Jin YANG, Gyeonggi-do (KR); Dong Guk SIM, Seoul (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/574,043

(22) Filed: Oct. 6, 2009

(30) Foreign Application Priority Data
Oct. 7, 2008 (KR) 10-2008-98310

(51) Int. Cl. B60T 8/48

(52) U.S. Cl. 303/11

(57) ABSTRACT

Disclosed herein is an electronic control brake system that has a compact structure while rapidly forming an oil pressure during active control and reducing pressure pulsation, simultaneously. The electronic control brake system includes a master cylinder assembly to provide braking force, a plurality of brake cylinders to achieve braking, first and second hydraulic circuits connecting the master cylinder and the plurality of brake cylinders to form a closed circuit, a pump unit installed in the first and second hydraulic circuits to achieve active control, and a motor to drive the pump unit. The pump unit includes first, second, third, and fourth pumps, the first pump and the second are respectively arranged in planes, being orthogonal with the rotary axis X of the motor, located in different layers in the direction of a rotary axis of the motor at an angular position of 0 degrees from the rotary axis of the motor, the third pump arranged in the same plane as the first pump at an angular position of 270 degrees from the rotary axis X of the motor, and the fourth pump is arranged in the same plane as the second pump at an angular position of 90 degrees from the rotary axis of the motor. The first pump and the third pump are connected to the first hydraulic circuit, and the second pump and the fourth pump are connected to the second hydraulic circuit.

### CROSS-REFERENCE TO RELATED APPLICATION

This application claims the benefit of Korean Patent Application No. 2008-0098310, filed on Oct. 7, 2008 in the Korean Intellectual Property Office, the disclosure of which is incorporated herein by reference.

### BACKGROUND

1. Field

Embodiments of the present invention relate to an electronic control brake system that has a compact structure while rapidly forming an oil pressure during active control and reducing pressure pulsation, simultaneously.

2. Description of the Related Art

In general, electronic control brake systems are used to effectively prevent slippage of a vehicle to obtain strong and stable braking force. As these electronic control brake systems, there have been developed an anti-lock brake system (ABS), which prevents wheels from slipping during braking, a brake traction control system (BTCS), which prevents driving wheels from slipping when a vehicle is abnormally started or accelerated, and a vehicle dynamic control system (VDC), which stably maintains a driving state of a vehicle by controlling a brake oil pressure in combination of the ABS and the BTCS.

Each of these electronic control brake systems includes multiple solenoid valves to control a brake oil pressure transmitted to hydraulic brakes mounted on wheels of a vehicle, low-pressure accumulators and high-pressure accumulators to temporarily store oil flown out of the hydraulic brakes, a motor and pumps to forcibly pump the oil of the low-pressure accumulators, and an ECU to control driving of the solenoid valves and the motor. These elements are installed in a modulator block made of aluminum.

Therefore, oil in a low-pressure state of the low-pressure accumulators is compressed and pumped to the high-pressure accumulators by the operation of the pumps, and the compressed oil is transmitted to the hydraulic brakes or a master cylinder assembly, thereby allowing a function of the ABS, the ETCS, or the VDC to be achieved.

However, the conventional electronic control brake system has two hydraulic circuits and is formed in a dual pump type, in which two pumps are simultaneously connected to one motor, such that one pump is disposed in each of the hydraulic circuits. Thus, as a rotary axis of the motor is rotated once, each pump performs one suction operation and one discharge operation and thus supplies compressed oil to each hydraulic circuit. Accordingly, a width of the pulsation of an oil pressure at the master cylinder assembly is large during the discharge operation of the pump, and formation of pressure of the hydraulic brakes by the operation of the pumps during active control is not rapidly carried out.

### SUMMARY

Therefore, it is one aspect of the present invention to provide an electronic control brake system that has a compact structure while rapidly forming an oil pressure during active control and reducing pressure pulsation, simultaneously.

Additional aspects of the invention will be set forth in part in the description which follows and, in part, will be obvious from the description, or may be learned by practice of the invention.

In accordance with one aspect of the present invention, an electronic control brake system including a master cylinder assembly to provide braking force, a plurality of brake cylinders to achieve braking, first and second hydraulic circuits connecting the master cylinder and the plurality of brake cylinders to form a closed circuit, a pump unit installed in the first and second hydraulic circuits to achieve active control, and a motor to drive the pump unit, wherein the pump unit includes first, second, third, and fourth pumps, the first pump and the second are respectively arranged in planes, being orthogonal with the rotary axis X of the motor, located in different layers in the direction of a rotary axis of the motor at an angular position of 0 degrees from the rotary axis of the motor, the third pump arranged in the same plane as the first pump at an angular position of 270 degrees from the rotary axis X of the motor, and the fourth pump is arranged in the same plane as the second pump at an angular position of 90 degrees from the rotary axis of the motor, and the first pump and the third pump are connected to the first hydraulic circuit, and the second pump and the fourth pump are connected to the second hydraulic circuit.

The two pumps connected to the first hydraulic circuit may be connected to one low-pressure accumulator at inlet sides thereof and connected to one high-pressure accumulator at outlet sides thereof, and the two pumps connected to the second hydraulic circuit may be connected to another low-pressure accumulator at inlet sides thereof and connected to another high-pressure accumulator at outlet sides thereof.

The number of the motor may be one.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic system diagram of an electronic control brake system in accordance with the present invention; and

FIG. 2 is a perspective view schematically illustrating an arrangement of a motor and a pump unit in accordance with the present invention.

### DETAILED DESCRIPTION

Reference will now be made in detail to the embodiments of the present invention, examples of which are illustrated in the accompanying drawings, wherein like reference numerals refer to like elements throughout.

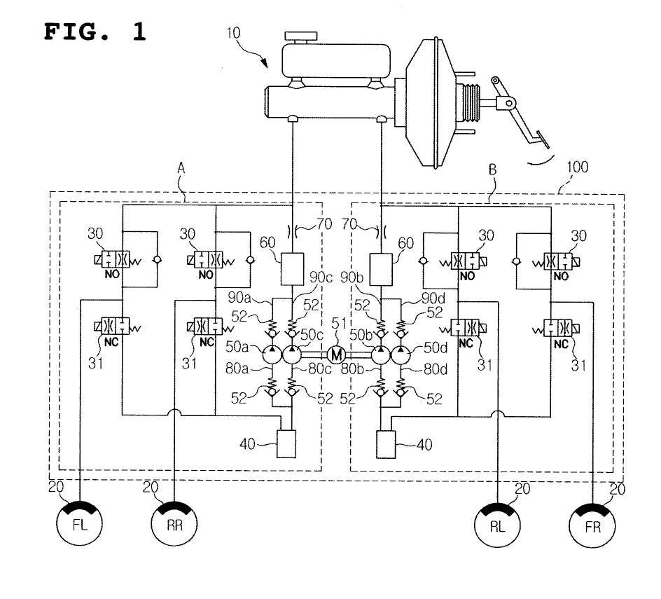

FIG. 1 is a hydraulic system diagram of an electronic control brake system in accordance with the present invention.

As shown in FIG. 1, the electronic control brake system in accordance with the present invention includes a master cylinder assembly 10 to provide braking force, a plurality of brake cylinders 20 to achieve braking, and a first hydraulic circuit A and a second hydraulic circuit B connecting the master cylinder 10 and the plurality of brake cylinders 20 to respectively form a closed circuit. Here, since the first hydraulic circuit A and the second hydraulic circuit B have the same arrangement structure, the second hydraulic circuit B has the same construction as that of the first hydraulic circuit A and thus a description thereof will be omitted except for a case that the construction of the second hydraulic circuit B is specially mentioned.

Each of the first and second hydraulic circuits A and B includes multiple solenoid valves 30 and 31 to intermit transmission of brake oil pressure formed by the master cylinder assembly 10 to the respective brake cylinders 20, and a low-pressure accumulator 40 to temporarily store oil returned from the brake cylinders 20.

The electronic control brake system in accordance with the present invention further includes a pump unit 50 to compress oil stored in the low-pressure accumulators 40 so as to re-circulate the oil, a motor part 51 to drive the pump unit 50, and high-pressure accumulators 60 to damp pressure pulsation of the oil discharged from the pump unit 50.

The pump unit 50 includes a first pump 50a, a second pump 50b, a third pump 50c, and a fourth pump 50d. Here, the first pump 50a and the third pump 50c are connected to the first hydraulic circuit A, and the second pump 50b and the fourth pump 50d are connected to the second hydraulic circuit B. Further, a check valve 52 to prevent backward flow of the oil is installed at inlet and outlet sides of each of the respective pumps 50a, 50b, 50c, and 50d.

All the above devices are compactly installed in a modulator block 100 having a rectangular parallelepiped shape made of aluminum, and multiple paths to interconnect the devices are installed in the modulator block 100.

The solenoid valves 30 and 31 are divided into normal open type solenoid valves (hereinafter, referred to as “NO type solenoid valves”) 30, which are disposed at upstream paths of the brake cylinders 20 and usually maintain an opened state, and normal close type solenoid valves (hereinafter, referred to as “NC type solenoid valves”) 31, which are disposed at downstream paths of the brake cylinders 20 and usually maintain a closed state.

The low-pressure accumulators 40 are disposed at paths connecting the downstream paths of the NC type solenoid valves 31 and the pump unit 50. Thus, the low-pressure accumulators 40 temporarily store oil returned from the brake cylinders 20 by the opening of the NC type solenoid valves 31, when braking is achieved by decompression of the brake cylinders 20. Further, the high-pressure accumulators 60 are disposed at paths connecting an outlet side of the pump unit 50 and the upstream paths of the NO type solenoid valves 30. Thus, the high-pressure accumulators 60 serve as damping chambers to damp the pressure pulsation of the oil discharged from the pump unit 50. Here, non-described reference numeral 70 is an orifice to stabilize the flow of a fluid.

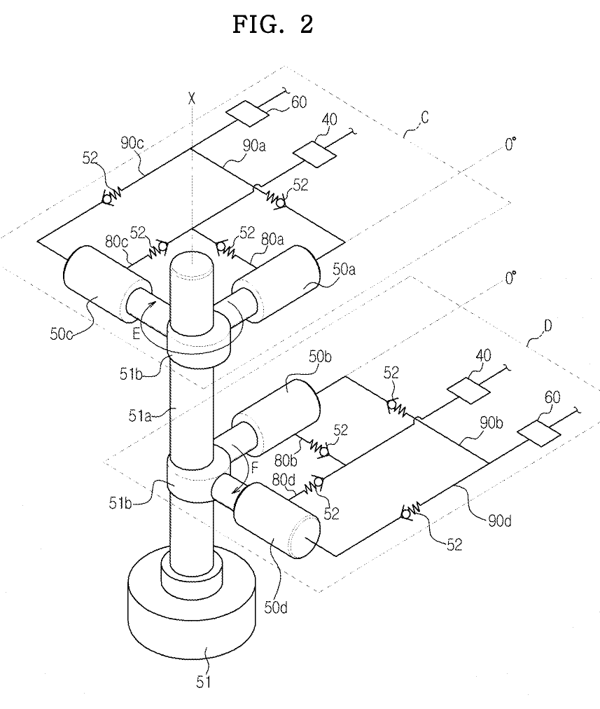

FIG. 2 is a perspective view schematically illustrating an arrangement of the motor and the pump unit in accordance with the present invention.

As shown in FIG. 2, the motor part 51 in accordance with the present invention includes a single motor with a shaft 51 a rotated around a rotary axis X, and two eccentric pieces 51b are provided at different positions of the shaft 51a in the direction of the rotary axis X.

The first pump 50a and the second pump 50b are respectively arranged in different layers in the direction of the rotary axis X of the motor at an angular position of 0 degrees from the rotary axis X of the motor, the third pump 50c is arranged at an angular position of 270 degrees from the rotary axis X of the motor, and the fourth pump 50d is arranged at an angular position of 90 degrees from the rotary axis X of the motor. Further, the first pump 50a and the third pump 50c are arranged in a plane C being orthogonal with the rotary axis X of the motor, and the second pump 50b and the fourth pump 50d are arranged in another plane D being orthogonal with the rotary axis X of the motor. In this embodiment, the first and third pumps 50a and 50c are connected to the first hydraulic circuit A, and the second and fourth pump 50b and 50d are connected to the second hydraulic circuit B.

Thereby, in the electronic control brake system of the present invention, since pressure formation is carried out twice in the respective first and second circuits A and B by one rotation of the rotary axis X, the cycle of a pressure pulse shortened and the width of the pressure pulse is decreased, thereby reducing vibration and noise of the system.

Further, in the electronic control brake system of the present invention, since two pumps 50a and 50b are arranged at the same angular position, i.e., at an angular position of 0 degrees from the rotary axis X, and the remaining two pumps 50c and 50d are arranged at both sides of the two pumps 50a and 50b, inlet paths 80a, 80b, 80c, and 80d and outlet paths 90a, 90b, 90c, and 90d of the respective pumps 50a, 50b, 50c, and 50d are arranged toward the same side, thereby facilitating spatial arrangement of the pumps 50a, 50b, 50c, and 50d and thus being capable of a compact path design.

The inlet paths 80a, 80b, 80c, and 80d and the outlet paths 90a, 90b, 90c, and 90d are formed in one direction, and thus the pumps 50a, 50b, 50c, and 50d easily own the low-pressure accumulators 40 and the high-pressure accumulators 60 in common. That is, as shown in FIG. 2, the two pumps 50a and 50c connected to the first hydraulic circuit A are connected to one low-pressure accumulator 40a at inlet sides thereof and are connected to one high-pressure accumulator 60a at outlet sides thereof, and the two pumps 50b and 50d connected to the second hydraulic circuit B are connected to another low-pressure accumulator 40b at inlet sides thereof and are connected to another high-pressure accumulator 60b at outlet sides thereof. Thereby, the design of a compact brake system becomes easier.

Although this embodiment exemplarily describes that the first and third pumps 50a and 50c are connected to the first hydraulic circuit A and the second and fourth pumps 50b and 50d are connected to the second hydraulic circuit B, two pumps respectively connected to the first and second hydraulic circuits may be adjusted according to the structures of the hydraulic circuits. For example, the first and second pumps 50a and 50b may be connected to the first hydraulic circuit A and the third and fourth pumps 50c and 50d may be connected to the second hydraulic circuit B.

Further, although this embodiment exemplarily describes that the four pumps 50a, 50b, 50c, and 50d are arranged two by two in the two planes C and D being orthogonal with the rotary axis X, the four pumps 50a, 50b, 50c, and 50d may be arranged one by one in four different planes.

Moreover, the hydraulic circuits of the present invention are exemplary, and thus the pump unit of the present invention may be applied to other hydraulic circuits.

As is apparent from the above description, an electronic control brake system in accordance with the present invention has a compact structure as well as rapidly forms an oil pressure during active control and reduces pressure pulsation, simultaneously.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic control brake system comprising a master cylinder assembly to provide braking force, a plurality of brake cylinders to achieve braking, first and second hydraulic circuits connecting the master cylinder and the plurality of brake cylinders to form a closed circuit, a pump unit installed in the first and second hydraulic circuits to achieve active control, and a motor to drive the pump unit, wherein:
the pump unit includes first, second, third, and fourth pumps, the first pump and the second are respectively arranged in planes, being orthogonal with the rotary axis X of the motor, located in different layers in the direction of a rotary axis of the motor at an angular position of 0 degrees from the rotary axis of the motor, the third pump arranged in the same plane as the first pump at an angular position of 270 degrees from the rotary axis X of the motor, and the fourth pump is arranged in the same plane as the second pump at an angular position of 90 degrees from the rotary axis of the motor; and
the first pump and the third pump are connected to the first hydraulic circuit, and the second pump and the fourth pump are connected to the second hydraulic circuit.

2. The electronic control brake system according to claim 1, wherein:
the two pumps connected to the first hydraulic circuit are connected to one low-pressure accumulator at inlet sides thereof and connected to one high-pressure accumulator at outlet sides thereof; and
the two pumps connected to the second hydraulic circuit are connected to another low-pressure accumulator at inlet sides thereof and connected to another high-pressure accumulator at outlet sides thereof.

3. The electronic control brake system according to claim 1, wherein the number of the motor is one.
